(19) United States
(12) Patent Application Publication
(10) Pub. No.: US 2005/0107037 A1
(43) Pub. Date: May 19, 2005

(54) Method and apparatus for augmenting bluetooth-type capabilities of a wireless terminal

(76) Inventors: Bart Delmulle, Ukkel (BE); Niko Eiden, Espoo (FI); Jarkko Kuntanen, Espoo (FI); Riitta Nieminen-Sundell, Helsinki (FI); Janne Jormalainen, Kauniainen (FI); Timo Sivula, Aspen Heights (SG)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/712,788

(22) Filed: Nov. 13, 2003

(51) Int. Cl. H04B 5/00

(52) U.S. Cl. 455/41.2; 455/553.1; 455/426.1

(57) ABSTRACT

An auxiliary device (10) for use with a UE device (12) such as a mobile phone, including: an interface (10a) with the UE device (12), providing at least part of an AUX-UE coupling (11a)—a wireless or plug connection—to the UE device (12); and a short-range transceiver (10b) (e.g. a Bluetooth transceiver), coupled to the interface (10a) with the UE device (12), for wirelessly communicating with short-range transceivers of peer devices (i.e. devices operated by users). The UE device (12) includes an AUX user interface (14b) providing a user interface to the apparatus (10) and operative in combination with a UE user interface (14a) included as part of the UE device (12). The short-range transceiver (10b) of the auxiliary device (10) typically has a longer range than is usual for such a transceiver. The auxiliary device (10) typically includes components enabling various user-user communications/interactions with nearby peer devices.

### TECHNICAL FIELD

The present invention pertains to the field of wireless communication. More particularly, the present invention pertains to the use of short-range transceivers in connection with use of a wireless terminal such as a mobile phone.

### BACKGROUND ART

The use of short-range wireless coupling provided e.g. by Bluetooth, i.e. by signals according to the so-called Bluetooth protocol, is typically used for coupling e.g. a computer to a printer, due largely to the fact that such coupling is typically effective over only shorter distances, often typically 10 m or less. (There has also been some use of Bluetooth for coupling between two or more individuals; see for example Bluetooth PAN profile.)

Since such short-range wireless coupling is inexpensive, i.e. there is at this time no billing on a per-coupling basis, it is attractive as a means of communication to the extent that it can be used in providing communication among users (people), even over the fairly short distances that are typical. For example, a user might have a blind date with another user, and each may have a Bluetooth transceiver (TRX). If each Bluetooth TRX is able to identify, then if the two users carry their respective Bluetooth TRXs to their first rendezvous, perhaps in a crowded area, each can be alerted by the respective Bluetooth TRX that the other user is nearby, and so help the two users to meet each other for their first assignation.

Even so, the use of such short-range communication is limited in its application due to the short-range typical of a Bluetooth TRX. Applications can be envisioned in which a user might want to know if another user—a friend of some sort—is nearby but outside the limited range of the typical short-range transceiver.

What is therefore needed is a way of providing for the use of a short-range transceiver in communication among one or more users (people), and ideally, a way of providing a longer-range short-range transceiver for use in such communication.

### DISCLOSURE OF THE INVENTION

Accordingly, in a first aspect of the invention, a method is provided for an apparatus for use with a UE device equipped for wireless cellular communication and including a UE user interface, the apparatus characterized in that it comprises: an interface with the UE device, providing at least part of a wireless or plug connection to the UE device, for communicating with the UE device; and a short-range transceiver, coupled to the interface with the UE device, for wirelessly communicating with short-range transceivers of peer devices.

In accord with the first aspect of the invention, the UE device may also include an auxiliary (AUX) user interface providing a user interface to the apparatus, and also, the UE user interface may be operative in combination with the AUX user interface application.

Also in accord with the first aspect of the invention, the short-range transceiver may be operative according to the BlueTooth protocol or a comparable short-range radio-wave based protocol.

Also in accord with the first aspect of the invention, the interface with the UE device may be coupled to the UE device using communication according to the BlueTooth protocol or another radiofrequency-based coupling protocol, or using an infrared-based coupling technology.

Also in accord with the first aspect of the invention, the short-range transceiver of the apparatus may be operative according to a predetermined protocol and may have a range at least several multiples of the range usual for a short-range transceiver operative according to the predetermined protocol.

Also in accord with the first aspect of the invention, the UE device may include an annunciator, and the apparatus may further comprise: a buddy detector application, coupled to the short-range transceiver, for receiving information including an identifier indicating a peer device or a user associated with a peer device, and in response providing to the annunciator a control signal actuating the annunciator, depending on the identifier; and a buddy list, for holding a list of buddies, with the list organized as records so as to be able to retrieve a record for a peer device or a user associated with a peer device based on the identifier associated with the peer device or a user associated with a peer device; and the buddy detector may check the buddy list for a record having the identifier included in the received information and may actuate the annunciator only upon finding such a record. Further, the identifier may be an identifier of a short-range transceiver associated with the predetermined buddy. Also further, the buddy identifier may be a nickname of the predetermined buddy. Also further, the buddy detector application may provide to the UE device information indicating the predetermined buddy for display to a user via the user interface of the UE device.

Also in accord with the first aspect of the invention, the short-range transceiver may be operative according to a predetermined protocol and may have a greater range than is usual for a short-range transceiver operative according to the predetermined protocol, and the apparatus may be further characterized in that it further comprises: a store and forward service application, for receiving communications via the short-range transceiver, for determining whether the communications have as an intended recipient a device peer to the apparatus but other than the apparatus, and for retransmitting any such communications via the short-range transceiver and including in the retransmission an identifier indicating a user of the apparatus, thereby providing to peer devices an increased-range short-range communication facility and allowing the user to take credit for providing the facility.

Also in accord with the first aspect of the invention, the apparatus may further comprise: a controller adapted to receive from another device a request for permission to control a stimulus generator, to present the request to a user via the UE user interface, to signal the user response to the request, to receive command signals indicating commands to cause one or another of various available stimuli sensations, and to provide stimulus control signals corresponding to the received command signals; and the stimulus generator, responsive to the stimulus control signals, for generating stimulus sensations corresponding to the stimulus control signals. Further, the stimulus generator may emit light of a color indicated by the stimulus control signal. Also further, the stimulus generator may emit sound indicated by the stimulus control signal.

Also in accord with the first aspect of the invention, the apparatus may further comprise: a personal web page administrator, responsive to signals from the short-range transceiver indicating the nearby presence of another short-range transceiver, for exchanging signals with a user of the UE device to determine whether to send a personal web page to the other short-range transceiver and for sending a web page to the other short-range transceiver; and a web page data store holding the personal web page.

Also in accord with the first aspect of the invention, the apparatus may further comprise: a phone list data store holding a list of phone numbers organized as records indexed based on a nickname identifier, for providing a phone number from the phone list data store in a guarded signal; and the UE device may also host an AUX agent of the apparatus, the AUX agent responsive to the guarded signal, for causing the phone number to be dialed by the UE device without revealing the phone number to the UE user interface, thereby keeping the phone number secret from a user of the UE device. Further, the AUX agent may be adapted so that the phone number is called only for sending an SMS message or other message, and not for enabling voice communication.

In a second aspect of the invention, a system is provided, comprising a telecommunications network including a radio access network, and further comprising a UE device, characterized in that the UE device is provided in combination with an apparatus according to the first aspect of the invention.

In a third aspect of the invention, a method is provided by which an apparatus according to the first aspect of the invention is operative, and also methods by which a UE device coupled is operative when coupled according to the first aspect of the invention to such an apparatus.

In a fourth aspect of the invention, a computer program product is provided comprising: a computer readable storage structure embodying computer program code thereon for execution by a computer processor in equipment comprising a UE device coupled to an AUX device, with said computer program code characterized in that it includes instructions for performing the steps of a method according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1A is a block diagram showing enhanced mobile phone including a UE device and also a coupled auxiliary device, which in turn includes a component for interfacing with UE device and also for controlling various components of the auxiliary device.

FIG. 1B is a block diagram showing the interfacing and controlling component of the auxiliary device of FIG. 1 in more detail.

FIG. 1C is a flow chart showing a method of operation of enhanced mobile phone of FIG. 1.

FIG. 2 is a schematic illustration of a record in data store holding a buddy list included in the auxiliary device of FIG. 1.

FIG. 3 is a schematic of a record in the data store holding a protected phone list in the auxiliary device of FIG. 1.

FIG. 4 is a flow chart showing a method of using an enhanced mobile in connection with a buddy list.

FIG. 5 is a flow chart of a method of using the enhanced mobile in connection with allowing a peer device to control a car generator included as part of the auxiliary device of the enhanced mobile.

FIG. 6 is a flow chart of the method of using the enhanced mobile in connection with sharing a personal web page with nearby users and also in connection with making it possible for nearby user to allow a user of the enhanced mobile to call without knowing the phone number of the nearby user.

FIG. 7 is a flow chart of a method of using the enhanced mobile as a kind of repeater station for nearby peer devices not having as great a range for short range communication (such as according to Bluetooth).

### BEST MODE FOR CARRYING OUT THE INVENTION

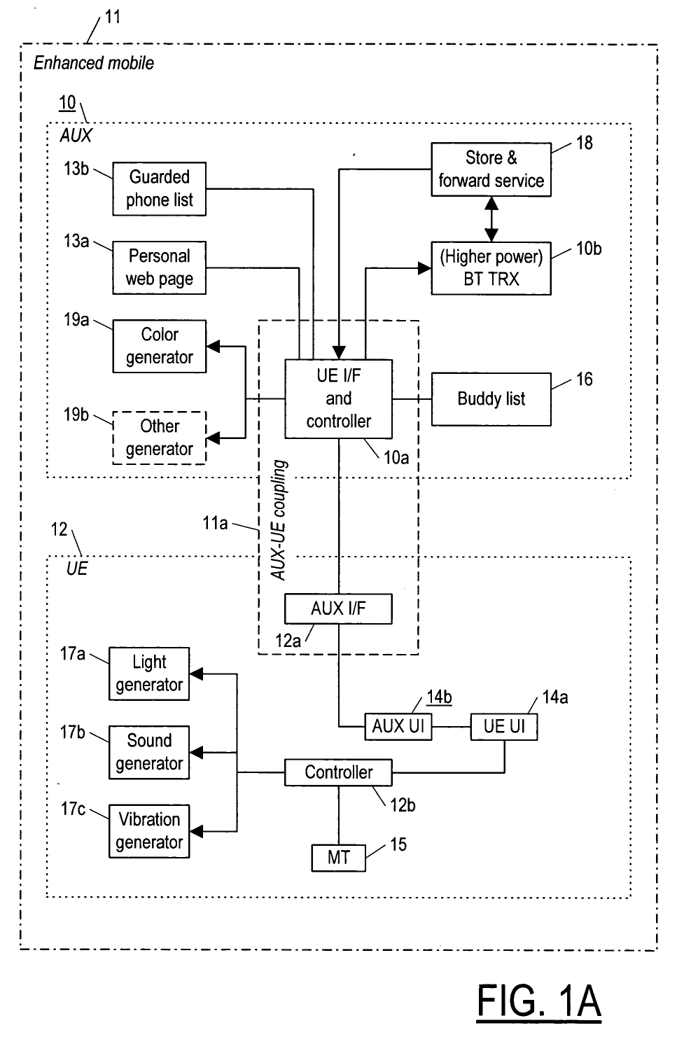

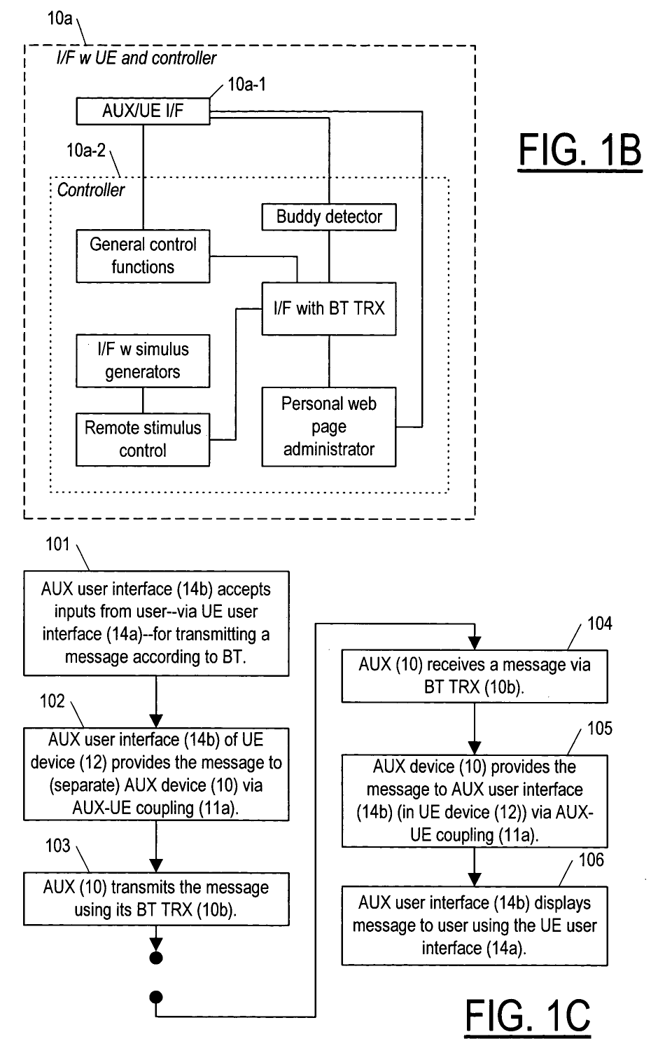

Referring now to FIG. 1A, the invention provides an auxiliary (AUX) device 10, having a short-range transceiver (TRX) 10b for communicating according to one or another radiofrequency-based short-range communication protocol, such as Bluetooth, and coupled wirelessly or otherwise to a UE device 12 (a wireless terminal, such as a mobile phone), where the UE device 12 is equipped for wireless cellular communication according to e.g. UMTS (Universal Mobile Telecommunication System), and so includes the usual terminal equipment having a UE user interface 14a (with a means of user input, such as a keypad and also a display device) and also includes a mobile terminal (MT) component 15 for communicating with a radio access network (not shown) of an operator network providing the wireless cellular communication. The AUX device 10 provides enhanced capabilities for the UE device 12 all in connection with communication according to the short-range communication protocol, and so the AUX device 10 and the UE device 12 in combination function as an enhanced UE device/enhanced mobile 11.

The invention is described in what follows assuming that the radiofrequency-based short-range communication protocol is Bluetooth (BT), and thus the short-range transceiver 10b is a Bluetooth transceiver (BT TRX), but it should be understood that nothing about the invention restricts it to Bluetooth. The invention encompasses having an AUX device 10 equipped for communication according to any radiofrequency-based short-range communication protocol. Such communication includes communication to what are here called peer devices, i.e. any other UE devices (i.e. devices used by a user for user-user communication) equipped to communicate according to the short-range communication protocol used by the enhanced mobile 11, that protocol assumed for purposes of the description here to be Bluetooth.

Referring now also to FIG. 1B, the AUX device 10 is coupled to the UE device 12 by an AUX-UE coupling 11a provided at the AUX end by a UE interface and controller component 10a, including a AUX/UE interface element 10a-1 and also an AUX controller 10a-2 coupled to the AUX/UE interface 10a-1 and including various functionality as described below. At the UE end, the AUX-UE coupling 11a is provided by an AUX interface 12a, which could be a generic interface to an external device. The AUX-UE coupling 11a can be itself according to the BlueTooth protocol or other radiofrequency-based coupling protocol, or can be an infrared-based coupling.

To communicate with the AUX device 10, the UE device 12 also includes an AUX user interface 14b (i.e. the AUX user interface is hosted by the UE device 12) providing a user interface to the AUX device 10. The UE user interface 14a is preferably configured so as to be operative in combination with the AUX user interface application 14b, the latter being provided e.g. as a JAVA/Symbian applet. Thus, for communication via Bluetooth, a user of the enhanced mobile 11 would use the UE user interface 14a, including whatever means is provided for user input (including voice or text or other user inputs) by the UE user interface 14a, for providing inputs in connection with use of the AUX device 10. The UE user interface 14a directs all input for the AUX device 10 to the AUX interface 12a, for delivery to the UE interface and controller component 10a.

According to the invention, the BT TRX 10b typically has a range at least several multiples of the range usual for a Bluetooth transceiver. For example, where a usual range is 10 m, the range of the BT TRX provided with the AUX device 10 can be up to ten times what is usual, or 100 m. As explained below, having a greater range than is usual is especially advantageous in some applications, such as an application where the enhanced mobile acts as a sort of amplifier station, receiving Bluetooth transmissions from normal-range Bluetooth transceivers and retransmitting the Bluetooth transmissions at its higher power.

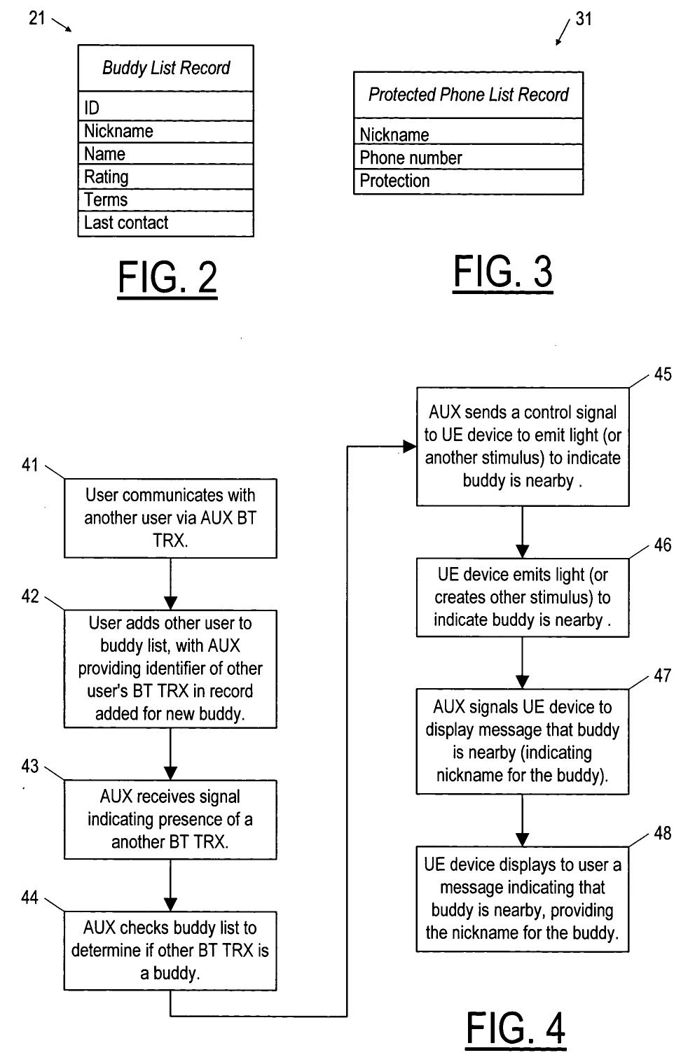

In some embodiments of the invention, and now also referring to FIG. 2, the UE device 12 includes an annunciator 17a-c of one or another type—i.e. a device generating one or another type of stimulus, such as a light generator 17a or a sound generator 17b or a vibration generator 17c—and the AUX device 10 also includes a buddy detector application, included e.g. as part of the AUX controller element 10a-2 and coupled to the BT TRX 10b, for receiving information including an identifier indicating a peer device or a user associated with a peer device, and in response providing to the annunciator 17a-c a control signal actuating the annunciator 17a-c, depending on the identifier, i.e. depending on whether the identifier is in a buddy list 16 stored in the AUX device 10. The buddy list 16 holds a list of what are here called buddies, i.e. simply other users the user of the enhanced mobile has communicated with via the BT TRX 10b and chosen to include in the buddy list 16. The buddy list 16 is organized as records 21 (FIG. 2) so as to be able to retrieve a record for a peer device or a user associated with a peer device based on the identifier associated with the peer device or a user associated with a peer device. The buddy detector checks the buddy list 16 for a record having the identifier included in the received information and actuates the annunciator 17a-c only upon finding such a record. The buddy detector also indicates to the user an identity for the buddy—such as the identifier received from the buddy or a nickname associated with the identifier if the identifier is not the nickname. Thus, the enhanced mobile 11 notifies a user that a buddy is nearby, in case the user wants to communicate with the buddy either via the BT TRX or otherwise.

FIG. 2 illustrates a possible record structure for the records of a buddy list 16 according to the invention, and shows both an identifier (ID) field as well as a nickname field, but it should be understood that in some embodiments that ID is advantageously simply the nickname of a buddy. In other embodiments, the ID can be associated with the peer device used by the buddy, i.e. it can be the identifier of a Bluetooth transceiver used by the buddy and included in transmissions by the Bluetooth transceiver used by the buddy. (Such identifiers might be used by the AUX device to distinguish between Bluetooth transceivers in devices used for user-user communications and Bluetooth transceivers in other kinds of devices—such as printers using Bluetooth to couple to computers, and so allowing the wireless sharing of the printers.) In addition, as shown, the record structure can include a (more full) name for the buddy, and also a rating value by which the user can rate the buddy—i.e. can indicate whether the buddy is a close friend or a mere acquaintance. In some cases the user may not want to communicate via Bluetooth with another peer device (or user of another peer device) and to accommodate such cases, the record structure can also include a terms field, by which the user can indicate whether or not there is to be communication, i.e. whether or not the user is “on speaking terms” with the buddy. In addition, and as a way of helping a user to recall having previously communicated with a buddy, a buddy list record can include a last contact field for indicating the time and date (and possibly location, depending on the capabilities of the enhanced mobile 11) of the last communication with the buddy via the BT TRX 10b.

In some embodiments, and typically especially in some of those in which the BT TRX 10b has a greater range than is usual, the AUX device 10 also includes a store and forward service application 18, coupled to the BT TRX 10b for receiving communications via the BT TRX 10b, for then determining whether the communications have as an intended recipient a device peer to the AUX device 10 (i.e. another device used for user-user communications) but one that is not the AUX device 10, and for broadcasting or otherwise transmitting any such communications via the BT TRX 10b. Such embodiments thus provide peer devices with an increased-range short-range communication facility, especially such embodiments having a greater-than-normal-range (i.e. higher power) BT TRX 10b, although even if the BT TRX 10b is of normal range, it can help propagate a transmission further from the originating peer device than the transmission would otherwise reach, at least in the direction pointing from the originating peer to the AUX device 10.

In some embodiments, the AUX controller element 10a-2 (FIG. 1B) is adapted to receive from another (peer) device a request for permission to control a stimulus generator 19a-b (FIG. 1A)) included as part of the AUX device 10. Such a stimulus generator 19a-b could be e.g. a color generator 19a, i.e. a device that emits light of a color that can be controlled by command. Another stimulus generator 19b could be a sound generator 19b, i.e. a device that emits a sound that can be controlled by command—e.g. command might indicate tunes or chords in a set of tunes or chords, or might indicate individual note. The AUX controller 10a-2, upon receiving such a request intended for the user of the UE device 12, presents it to the user via the UE user interface 14a, signals the user response to the request, and then, depending on the response, receives from the other (peer) device command signals indicating commands to cause one or another of various available stimuli sensations—such as emitting green light, and provides to the stimulus generator 19a-b stimulus control signals corresponding to the received signals, which then provides the indicated stimulus.

In some embodiments, the AUX device 10 also includes a personal web page administrator e.g. included as part of the AUX controller 10a-2. The personal web page administrator enables a user to create and maintain a personal web page 13a stored in the AUX device 10, and to send it to another user via the BT TRX 10b when the other user is nearby (near enough to be within the range of the BT TRX 10b). The AUX device 10 is configured so that the personal web page administrator receives either directly or indirectly signals from the BT TRX 10b indicating the nearby presence of a Bluetooth transceiver of a peer device. It then seeks permission from the user of the UE device 12 to send the user's personal web page to the peer device, using the UE user interface 14a via the AUX user interface 14b in the UE device 12. If permission is granted, it retrieves the personal web page from the data store 13a where it is stored, and sends it to the other Bluetooth transceiver via the BT TRX 10b.

Referring now also to FIG. 3, in some embodiments, possibly related to those in which the personal web page administrator is provided, the AUX device 10 also includes a protected phone list (data store) 13b holding a list of phone numbers organized as records 31 (FIG. 3) so as to allow retrieving a phone number based on a nickname identifier, i.e. so that the phone list 13b is indexed based on the nickname identifier. To allow a user of the UE device 12 to communicate with another user via the cellular communication network (and so over no longer over just the range allowed by the short-range TRX 10b) but not know the phone number of the other user—which is possibly desirable in a situation in which two people are considering getting to know each other better and one wants the other to be able to communicate but not to know the phone number—the enhanced mobile 11 is configured so that the user can indicate via the AUX user interface 14b a command to send an SMS message (or an MMS message or any other kind of prepared message, as opposed to making a voice call) to the other, identifying the other user by nickname (in the To: block of the SMS message), and the AUX user interface 14b then interfaces with the AUX device 10 to retrieve the phone number of the other user from the protected phone list 13b, and the AUX user interface 14b then places the call using the MT component 15 of the UE device 12, without revealing the phone number to the user, i.e. without communicating it to the UE user interface 14a, and sends the SMS message. (Of course it is possible to have in the UE device 12 a component different than the AUX user interface component 14b but also associated with the AUX device 10 for receiving such cellular phone numbers to be called without revealing to the user the actual cellular phone number calls.) As shown in FIG. 3, a record 31 in the protected phone list 13b can include a nickname, used as the index, an associated cellular phone number, and a protection field used for indicating whether the phone number is to be kept from the user or not. In embodiments including the protection field, of course only the other user would be allowed to alter the protection field.

Referring now to FIG. 1C, the invention is illustrated as a method that in general includes, for transmitting a message using the AUX device 10, a first step 101 in which the AUX user interface 14b accepts inputs from user—via the UE user interface 14a, i.e. with the AUX user interface 14b operative in combination with or as part of the UE user interface 14a—for transmitting a message according to Bluetooth. In a next step 102 the UE device (12)—and more specifically the AUX user interface 14a—provides the message to the AUX device device 10 transmits the message using its BT TRX 10b. In a next step 103 the AUX device 10 transmits the message using the BT TRX 10b.

Still referring now to FIG. 1C, there are also corresponding steps for receiving a message using the AUX device 10. For receiving a message, the invention provides a first step 104 in which the AUX device 10 receives a message via the BT TRX 10b. In a next step 105, the AUX device 10 provides the message to the UE device 12 via the AUX UE coupling 11a; more specifically, the AUX device provides a message to the AUX user interface 14b. In a last step 106, the AUX user interface 14b displays the message to the user using the UE interface 14a (and in particular using whatever display or sound device is provided as part thereof).

Referring now to FIG. 4, use of the invention in the embodiment including the buddy list 16 is shown as a method including steps for adding a buddy to the buddy list 16 and also steps for alerting the user that a buddy is nearby. In adding a buddy to the buddy list 16, there is a first step 41 in which the user communicates with another user via the BT TRX 10b in the AUX device 10. In a next step 42, the user adds another user to the buddy list 16. When the record for the new buddy is added to the buddy list 16, the AUX device provides an identifier for the other user's Bluetooth transceiver, an identifier that is provided as part of the transmission of the other transceiver and that uniquely identifies that transceiver.

Still referring to FIG. 4, for alerting the user that a buddy is nearby, there is a step 33 in which the AUX device 10 receives a signal indicating the presence of the other user Bluetooth transceiver. In a next step 44, the AUX device checks the buddy list 16 to determine whether the other Bluetooth transceiver is (i.e. is associated with) a buddy, i.e. whether the other Bluetooth transceiver is indicated by an identifier included in the buddy list 16. If so, then in a next step 45, the AUX device sends a control signal to the UE device 12 so as to cause the UE device to emit light or to create some other stimulus to alert the user that a buddy is nearby. In a next step 46, the UE device 12 emits light or creates the other stimulus so as to indicate that the buddy is nearby. In a next step 47, besides alerting the buddy that a buddy is nearby, the AUX device 10 signals the UE device 12 (and more specifically, the AUX device 10 signals the AUX user interface 14b of the UE device 12) so as to cause the UE device 12 to display a message that a buddy is nearby and also to indicate a nickname for the buddy, an AUX device 12 having retrieved the nickname for the buddy, the nickname in the record 21 for the buddy in the buddy list 16. (Such a nickname would have been provided at the time the record for the buddy list was first added to the buddy list 16 by the AUX device, and could have either been provided by the buddy or by the user.) In a next step 48, the UE device does display to the user a message indicating not only that buddy is nearby, but also providing the nickname for the buddy.

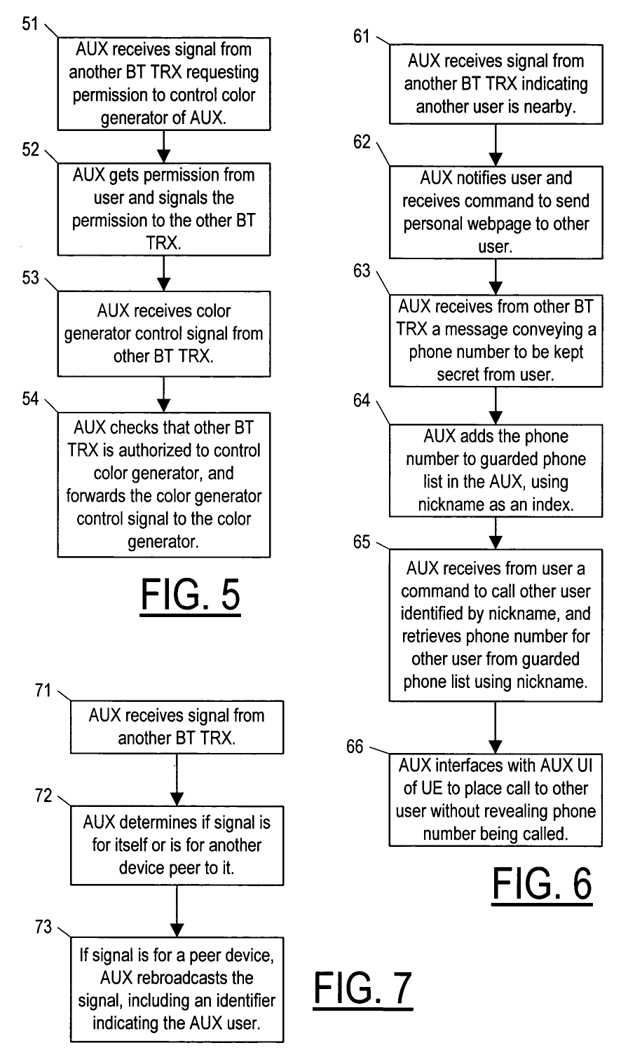

Referring now to FIG. 5, the embodiment of the invention in which another user controls colors emitted by the AUX device 10 is shown being used according to a method including a first step 51 in which the AUX device 10 receives a signal from another Bluetooth transceiver requesting permission to control the color generator 19a (or some other stimulus generator 19b) of the AUX device 10. A signal requesting permission is optional, and instead the first signal received in connection with controlling the color generator may be simply a command to change the color emitted by the color generator to one or another of the possible colors, in which case the AUX device 10 would simply treat the initial command as a request and get permission from the user to allow control of the color generator by the other Bluetooth transceiver. Thus, in a next step 52, the AUX device 10 gets permission from the user and in case of the situation in which the other Bluetooth transceiver did actually request permission (as opposed to sending a command to change color), the AUX device 10 signals the permission to the other Bluetooth transceiver. In a next step 53, the AUX 10 receives a color generator control signal from the other Bluetooth transceiver. In a next step 54, the AUX device 10 optionally checks that the other Bluetooth transceiver is in fact authorized to control the color generator (i.e. that the user has just recently given permission to do so) and if so forwards the color generator control signal to the color generator 19a, but if not, gets permission from the user to allow control by the other Bluetooth transceiver. Allowing control of the color permitted by the color generator 19a has various uses, including allowing another transceiver to identify itself via a color code known to the user, but also including simply allowing the user of the other of Bluetooth transceiver to express sentiment to the user by issuing a judicious sequence of color generator control signals.

Referring now to FIG. 6, the use of the invention is shown for the embodiment in which the user shares a personal web page with another user, and also for an embodiment in which the other user allows the user to place a call via the cellular communication system so as to be able to send for example an email or SMS message to the other user, without the user ever actually knowing the other users cellular phone number. Thus, as shown, in a first step 61 the AUX device 10 receives a signal from another Bluetooth transceiver indicating another user is nearby. In a next step 62, the AUX device 10 notifies the user and receives a command from the user to send the users personal web page to the other user. In a next step 63, the AUX device receives from the Bluetooth transceiver of the other user a message conveying a phone number to be kept secret from the user. In a next step 64, the AUX device 10 adds the phone number to the guarded phone list 13b using a nickname as an index by which to retrieve the phone number. The nickname can be created by the user or for either by the other user. In a next step 65 the AUX device can receive from the user a command to call the other user identified by nickname, and retrieve the phone number for the other user from the guarded phone list based on the nickname. In a next step 66, the AUX device 10 interfaces with the AUX user interface 14b of the UE device 12 to cause a call to be placed to the other user via the cellular communication network—i.e. using the MT component 15 of the UE device 12—without revealing the phone number to the UE user interface 14a, and so keeping the phone number secret from the user.

Referring now to FIG. 7, the use of the invention for providing a longer-range short-range communication facility for other users is shown including a first step 71 in which the AUX device 10 receives a signal from another Bluetooth TRX. In a next step 72, the AUX device 10 determines whether the signal is intended for itself or is for another device that is a peer device, i.e. is for another user as opposed to for example being a signal intended for a printer. In a next step 73, if the signal is for a PEER device, the AUX device 10 rebroadcasts the signal. If the signal was originally broadcast by a normal-range Bluetooth transceiver, the rebroadcast of the signal by the BT TRX 10b of the AUX device amounts to an amplification of the signal for embodiments in which the BT TRX 10b is a longer-range Bluetooth transceiver. As explained above, the examination of the originally received signal to determine whether or not it is for a peer device is performed by the store and forward service 18. If the store and forward service determines instead that the signal is a signal intended for the user of the enhanced mobile 11, it provides it to the UE interface and controller module 10a of the AUX device 10, which then provides it to the UE device 12, and in particular to the AUX user interface 14b, which then provides it to the UE user interface 14a for display to the user. Thus, all transmissions received by the BT TRX 10b of the AUX device 10 pass through the store and forward service 18. On the other hand, messages that are to be transmitted by the BT TRX 10b do not pass through the store and forward service 18. (Instead, messages to be transmitted are provided to the BT TRX 10b directly from the UE interface and controller module 10a.) In providing the store and forward service, the rebroadcast of a signal preferably includes the user name or some other identifier indicating the user of the AUX device 10, so as to have the other Bluetooth TRX receiving the rebroadcast appreciate who is performing the service.

It is important to note that although the invention has been described above in embodiments in which the UE device 12 is physically separate from the AUX device 10 (but includes an associated component, the AUX user interface 14b), nothing about the invention so restricts it. The invention comprehends having the AUX device 10 and the UE device 12 provided as what for all intents and purposes is an integral enhanced mobile device 11, although the overall arrangement of the components of the enhanced mobile device 11 is preferably as shown in FIG. 1A, which provides the AUX device 10 separated from the UE device 12 but coupled thereto via the AUX-UE coupling means 11a. Such an arrangement allows adding the AUX device functionality to UE devices of various design. However, other arrangements are also possible in which the AUX device 10 is more and more fully integrated with the UE device 12.

As explained above, the invention provides both a method and corresponding equipment consisting of various modules providing the functionality for performing the steps of the method. The modules may be implemented as hardware, or may be implemented as software or firmware for execution by a processor. In particular, in the case of firmware or software, the invention can be provided as a computer program product including a computer readable storage structure embodying computer program code—i.e. the software or firmware—thereon for execution by a computer processor included with the equipment.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. An apparatus (10) for use with a UE device (12) equipped for wireless cellular communication and including a UE user interface (14a), the apparatus characterized in that it comprises:
an interface (10a) with the UE device (12), providing at least part of a wireless or plug connection to the UE device (12), for communicating with the UE device (12); and
a short-range transceiver (10b), coupled to the interface (10a) with the UE device (12), for wirelessly communicating with short-range transceivers of peer devices.

2. The apparatus (10) of claim 1, further characterized in that the UE device (12) also includes an AUX user interface (14b) providing a user interface to the apparatus (10), and also in that the UE user interface (14a) is operative in combination with the AUX user interface application (14b).

3. The apparatus (10) of claim 1, wherein the short-range transceiver (10b) is operative according to the BlueTooth protocol or a comparable short-range radio-wave based protocol.

4. The apparatus (10) of claim 1, wherein the interface (10a) with the UE device (12) is coupled to the UE device using communication according to the BlueTooth protocol or other radiofrequency-based coupling protocol, or using an infrared-based coupling technology.

5. The apparatus (10) of claim 1, wherein the short-range transceiver (10b) of the apparatus (10) is operative according to a predetermined protocol and has a range at least several multiples of the range usual for a short-range transceiver operative according to the predetermined protocol.

6. The apparatus (10) of claim 1, wherein the UE device (12) includes an annunciator (17a-c), and wherein the apparatus (10) is further characterized in that it further comprises:
a buddy detector application (10a-2), coupled to the short-range transceiver (10b), for receiving information including an identifier indicating a peer device or a user associated with a peer device, and in response providing to the annunciator (17a-c) a control signal actuating the annunciator (17a-c), depending on the identifier; and
a buddy list (16), for holding a list of buddies, with the list organized as records (21) so as to be able to retrieve a record for a peer device or a user associated with a peer device based on the identifier associated with the peer device or a user associated with a peer device;
wherein the buddy detector checks the buddy list (16) for a record having the identifier included in the received information and actuates the annunciator (17a-c) only upon finding such a record.

7. The apparatus of claim 6, wherein the identifier is an identifier of a short-range transceiver associated with the predetermined buddy.

8. The apparatus of claim 6, wherein the buddy identifier is a nickname of the predetermined buddy.

9. The apparatus of claim 6, wherein the buddy detector application (10a) provides to the UE device (12) information indicating the predetermined buddy for display to a user via the user interface (15a) of the UE device (12).

10. The apparatus (10) of claim 1, wherein the short-range transceiver (10b) is operative according to a predetermined protocol and has a greater range than is usual for a short-range transceiver operative according to the predetermined protocol, and wherein the apparatus (10) is further characterized in that it further comprises:
a store and forward service application (18), for receiving communications via the short-range transceiver (10b), for determining whether the communications have as an intended recipient a device peer to the apparatus (10) but other than the apparatus (10), and for retransmitting any such communications via the short-range transceiver (10b) and including in the retransmission an identifier indicating a user of the apparatus (10), thereby providing to peer devices an increased-range short-range communication facility and allowing the user to take credit for providing the facility.

11. The apparatus (10) of claim 1, further characterized in that it further comprises:
a controller (10a-2) adapted to receive from another device a request for permission to control a stimulus generator (19a-b), to present the request to a user via the UE user interface (14a), to signal the user response to the request, to receive command signals indicating commands to cause one or another of various available stimuli sensations, and to provide stimulus control signals corresponding to the received command signals; and
the stimulus generator (19a-b), responsive to the stimulus control signals, for generating stimulus sensations corresponding to the stimulus control signals.

12. The apparatus (10) of claim 11, wherein the stimulus generator (19a-b) emits light of a color indicated by the stimulus control signal.

13. The apparatus (10) of claim 11, wherein the stimulus generator (19a-b) emits sound indicated by the stimulus control signal.

14. The apparatus (10) of claim 1, further characterized in that it further comprises:
a personal web page administrator (10a), responsive to signals from the short-range transceiver (10b) indicating the nearby presence of another short-range transceiver, for exchanging signals with a user of the UE device (12) to determine whether to send a personal web page to the other short-range transceiver and for sending a web page to the other short-range transceiver; and
a web page data store (13a) holding the personal web page.

15. The apparatus (10) of claim 1, further characterized in that it further comprises:
a phone list data store (13b) holding a list of phone numbers organized as records (31) indexed based on a nickname identifier, for providing a phone number from the phone list data store (13b) in a guarded signal;
and wherein the UE device (12) also hosts an AUX agent (14b) of the apparatus (10), the AUX agent (14b) responsive to the guarded signal, for causing the phone number to be dialed by the UE device (12) without revealing the phone number to the UE user interface (14a), thereby keeping the phone number secret from a user of the UE device (12).

16. The apparatus of claim 15, wherein the AUX agent (14b) is adapted so that the phone number is called only for sending an SMS message or other message, and not for enabling voice communication.

17. A system, comprising a telecommunications network including a radio access network, and further comprising a UE device (12), characterized in that the UE device (12) is provided in combination with an apparatus (10) as in claim 1.

18. A method for use by a UE device (12) equipped for wirelessly communicating according to a cellular communication protocol, the method for use in also wirelessly communicating with a peer device according to a short-range wireless communication protocol, the method characterized in that it comprises:
a step (101 106) in which the UE device (12) interfaces with a user to display messages communicated according to the short-range wireless communication protocol or to accept messages for communication according to the short-range wireless communication protocol, the interfacing with the user being via a AUX user interface (14b) providing a user interface to an external auxiliary device (10) coupled to the UE device (12) via a coupling arrangement (10a 12a); and
a step (102 105) in which the UE device (12) provides to the auxiliary device (10) the messages received from the user for communication according to the short-range wireless communication protocol via a short-range transceiver (10b) included as part of the auxiliary device (10), or in which the UE device (12) receives from the auxiliary device (10) the messages received via the short-range transceiver (10b) for display to the user.

19. The method of claim 18, further characterized in that the AUX user interface (14b) is operative in combination with a UE user interface (14a) providing a user interface to the UE device (12).

20. The method of claim 18, wherein the short-range transceiver (10b) is operative according to the BlueTooth protocol or a comparable short-range radio-wave based protocol.

21. The method of claim 18, wherein the interface (10a) with the UE device (12) is coupled to the UE device using communication according to the BlueTooth protocol or other radiofrequency-based coupling protocol, or using an infrared-based coupling technology.

22. The method of claim 18, wherein the short-range transceiver (10b) of the apparatus (10) is operative according to a predetermined protocol and has a range at least several multiples of the range usual for a short-range transceiver operative according to the predetermined protocol.

23. The method of claim 18, wherein the UE device (12) includes an annunciator (17a-c), and wherein the method is further characterized in that it further comprises:
a step (43) in which a buddy detector application (10a), coupled to the short-range transceiver (10b), receives via the short-range transceiver (10b) information indicating a peer device based on an identifier included in the information;
a step (44 45) in which the buddy detector application (10a) checks a buddy list (16), used for holding a list of buddies with the list organized as records (21) so as to be able to retrieve a record based on the identifier, and determines whether the identifier of the peer device indicates a buddy in the buddy list (16) and if so, provides to the annunciator (17a-c) a control signal actuating the annunciator (17a-c).

24. The method of claim 23, wherein the identifier is an identifier of a short-range transceiver included as part of the peer device.

25. The method claim 23, wherein the identifier is a nickname of a user associated with the peer device.

26. The method of claim 23, further comprising a step (47) in which the buddy detector application (10a) provides to the UE device (12) the buddy indicated by the identifier, for display to a user via the user interface (15a) of the UE device (12).

27. The method of claim 18, wherein the short-range transceiver (10b) is operative according to a predetermined protocol and has a greater range than is usual for a short-range transceiver operative according to the predetermined protocol, and wherein the method is further characterized in that it further comprises:
a step (71 72) in which a store and forward service application (18) hosted by the auxiliary device (10) receives communications via the short-range transceiver (10b) and determines whether the communications have as an intended recipient a device peer to the auxiliary device (10) but other than the auxiliary device (10); and
a step (73) in which the store and forward service application (18) retransmits any such communications via the short-range transceiver (10b) and including in the retransmission an identifier indicating a user of the auxiliary device (10), thereby providing to peer devices an increased-range short-range communication facility and allowing the user to take credit for providing the facility.

28. The method of claim 18, further characterized in that it further comprises:
a step (53) in which a controller (10a) hosted by the auxiliary device (10 receives from a peer device via the short-range transceiver (10b) stimulus control signals indicating commands to cause one or another of various available stimuli sensations; and
a step (54) in which the controller (10a) provides the stimulus control signals to a stimulus generator (19a-b) for generating stimuli sensations corresponding to the stimulus control signals.

29. The method of claim 28, wherein the stimulus generator emits light of a color indicated by the stimulus control signal.

30. The method of claim 28, wherein the stimulus generator emits sound indicated by the stimulus control signal.

31. The method of claim 18, further characterized in that it further comprises:
a step (61) in which a personal web page administrator (10a) receives signals via the short-range transceiver (10b) indicating the nearby presence of another short-range transceiver (10b); and
a step (62) in which the personal web page administrator (10a) uses the short-range transceiver (10b) to send the personal web page to the other short-range transceiver.

32. The method of claim 18, further characterized in that it further comprises:
a step (64) in which the auxiliary device (10) adds a phone number to a phone list data store (13b) holding a list of phones organized as records (31) indexed based on a nickname identifier;
a step (65) in which the auxiliary device (10) provides to an AUX component (14b) hosted by the UE device (12) a phone number to call via the cellular communication network, along with an associated nickname; and
a step (66) in which the AUX component (14b) places the call while displaying to a user of UE device (12) the nickname but not the number being called.

33. The method of claim 32, wherein the AUX agent (14b) is adapted so that the phone number is called only for sending an SMS message or other message, and not for enabling voice communication.

34. A computer program product comprising: a computer readable storage structure embodying computer program code thereon for execution by a computer processor in equipment (11) comprising a UE device (11) coupled to an AUX device (10), with said computer program code characterized in that it includes instructions for performing the steps of the method of claim 18.
